(19) United States
(12) Patent Application Publication
(10) Pub. No.: US 2013/0171498 A1
(43) Pub. Date: Jul. 4, 2013

(54) SEPARATORS AND METHOD OF FABRICATING THE SAME

(71) Applicants: Jung-Ching HSING, Hsinchu City (TW); Tzu-Hsien Han, Hsinchu City (TW); Shu-Hui Cheng, Hsinchu County (TW); Wan-Shu Chen, Hsinchu City (TW)

(72) Inventors: Jung-Ching HSING, Hsinchu City (TW); Tzu-Hsien Han, Hsinchu City (TW); Shu-Hui Cheng, Hsinchu County (TW); Wan-Shu Chen, Hsinchu City (TW)

(21) Appl. No.: 13/569,513

(22) Filed: Aug. 8, 2012

(30) Foreign Application Priority Data
Dec. 29, 2011 (TW) 100149469

(51) Int. Cl. H01M 2/16

(52) U.S. Cl. 429/145; 429/249; 427/58

(57) ABSTRACT

A method of fabricating a separator is provided. The method includes providing a porous non-woven substrate, and coating a first resin on the non-woven substrate, wherein the first resin includes hydrophilic oxyalkyl compounds, oxyalkyl polymers, oxyalkenyl alkyl polymers or derivatives thereof. The disclosure also provides a separator prepared by the method.

### CROSS REFERENCE TO RELATED APPLICATIONS

This application claims priority of Taiwan Patent Application No. 100149469, filed on Dec. 29, 2011, the entirety of which is incorporated by reference herein.

### TECHNICAL FIELD

The technical field relates to a method of fabricating a separator and a separator fabricated thereby.

### BACKGROUND

A lithium battery or lithium ion battery mainly comprises an anode of lithium alloy oxide, an organic liquid electrolyte, a separator, and a carbon cathode. The organic electrolyte for conducting ionic charges is filled in the pores of the battery structure. The separator disposed between the anode and cathode is utilized to separate the anode and cathode to prevent short circuiting therebetween.

Some fundamental properties, for example, effectiveness in separation of the anode and cathode, a porous structure, superior mechanical intensity and elasticity, resistance to corrosion of electrolyte, resistance to oxidation, chemical stability, low weight, thin profile, and high electrolyte content are essential for separators utilized in batteries, especially low weight, thin profile, high porosity, small pore size, superior mechanical intensity and resistance to oxidation, preferably thermal resistance. Currently, rubber, PVC or paper used for separators suffers from large resistance, low anti-seismic ability, and ineffectiveness for closed batteries. Use of glass fiber is limited due to its brittleness and pollution problem. Recently, polyethylene (PE) and polypropylene (PP) separators are popular. They can be formed of a single layer, multiple layers or composite layers. For a composite layer of polypropylene/polyethylene/polypropylene, when the polyethylene is melted to close cells, the outer polypropylene will often maintain its original mechanical properties due to a higher melting point thereof than the polyethylene. However, during processes, if the temperature is continuously increased, the outer polypropylene will melt away resulting in the short circuiting of batteries and high-temperature combustion.

In accordance with various batteries, non-woven fabrics, a three-dimensional network structure, with 80% porosity, can be correspondingly formed into proper separators with various pore sizes. A soft non-woven fabric with thermal stability has been widely applied in battery fabrication.

### SUMMARY

One embodiment of the disclosure provides a method of fabricating a separator, comprising the following steps: providing a porous non-woven substrate; and coating a first resin on the non-woven substrate, wherein the first resin comprises hydrophilic oxyalkyl compounds, oxyalkyl polymers, oxyalkenyl alkyl polymers or derivatives thereof.

One embodiment of the disclosure provides a separator, prepared by the disclosed method of fabricating a separator, wherein the separator has a pore size ranging from 50 nm to 800 nm and porosity ranging from 40% to 80%.

One embodiment of the disclosure provides a separator, comprising: a porous non-woven substrate; and a first resin coated on the non-woven substrate, wherein the first resin comprises hydrophilic oxyalkyl compounds, oxyalkyl polymers, oxyalkenyl alkyl polymers or derivatives thereof, and the separator has a pore size ranging from 50 nm to 800 nm and porosity ranging from 40% to 80%.

In the disclosure, a porous non-woven fabric (e.g., polyethylene terephthalate (PET), polyethylene (PE) or polypropylene (PP)), having a three-dimensional network structure with softness, thermal stability and more than 80% porosity, is utilized as a separator substrate, and combined with a first resin (e.g., hydrophilic resin such as hydrophilic oxyalkyl compounds, oxyalkyl polymers, oxyalkenyl alkyl polymers or derivatives thereof) coated thereon by using a hot-pressing machine or a roll-pressing machine to press the first resin into the pores of the substrate, to fabricate a thin (thickness: less than 30 μm) porous polyolefin separator with more than 50% porosity. The pore size can be further controlled to be less than 1 μm by adjusting resin viscosity (100-20,000 cp), drying temperature and pressing temperature (50-200° C.). Optionally, the non-woven substrate is first pressed to narrow its pore size to about 1 μm before coating the resin thereon. The resin viscosity and pressing temperature are then adjusted to control the pore size of the separator to he less than 1 μm.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawing, wherein:

FIG. 1 is a diagram of charge/discharge of a lithium battery of a Comparative Example.

FIG. 2 is a diagram of charge/discharge of a lithium battery according to an embodiment of the disclosure.

FIG. 3 shows variations of capacitance of a separator of a lithium battery under various discharge currents according to an embodiment of the disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

One embodiment of the disclosure provides a method of fabricating a separator, comprising the following steps. First, a porous non-woven substrate is provided. In an embodiment, the porous non-woven substrate may comprise polyethylene terephthalate (PET), polyethylene (PE) or polypropylene (PP).

In an embodiment, the non-woven substrate is then pressed by, for example, a hot-pressing method or a roll-pressing method to reduce the thickness thereof. In an embodiment, the non-woven substrate is pressed by a hot-pressing method at a temperature of about 50-200° C. for about 3-4 hours. The pressed non-woven substrate has a thickness of about 20-30 μm.

In another embodiment, the non-woven substrate is pressed by a roll-pressing method at a temperature of about 50-200° C. The pressed non-woven substrate has a thickness of about 20-25 μm.

Next, a first resin is coated on the non-woven substrate. In an embodiment, the first resin coated on the non-woven substrate may comprise hydrophilic oxyalkyl compounds, oxyalkyl polymers, oxyalkenyl alkyl polymers or derivatives thereof, for example, polyoxyethylene alkyl ether, polyoxypropylene alkyl ether, polyoxyethylene alkyl phenyl ether, polyoxyethylene-polyoxypropylene alcohol, polyoxyethylene fatty acid ester, trialkylamine oxide, polyoxyethylene lauric acid ester, polyethylene glycol, polyvinyl alcohol or fatty alcohol polyoxyethylene ether sulfate.

The first resin is further pressed into the pores of the non-woven substrate by, for example, a hot-pressing method or a roll-pressing method after the first resin is coated on the non-woven substrate.

In an embodiment, the first resin is pressed into the non-woven substrate by a hot-pressing method at a temperature of about 50-200° C. for about 3-4 hours.

In another embodiment, the first resin is pressed into the non-woven substrate by a roll-pressing method at a temperature of about 50-200° C.

A second resin is further coated on the non-woven substrate after the first resin is pressed into the non-woven substrate. The second resin may comprise hydrophobic poly(vinylidene difluoride) (PVDF), polyacrylonitrile, acrylic, or derivatives thereof or a combination thereof.

In an embodiment, an inorganic material is further mixed in the second resin. The inorganic material mixed in the second resin may comprise aluminum oxide, zirconium oxide, magnesium oxide, titanium oxide, or the like or a combination thereof. The amount of the inorganic material may be 1-5% of the weight of the second resin solution (after the second resin solution is prepared, the inorganic material with an amount of 1-5% of the weight of the second resin solution is added).

Next, the non-woven substrate is placed in a water bath to fix the pore size thereof.

The second resin is then pressed into the pores of the non-woven substrate to form a porous separator. In an embodiment, the second resin is pressed into the non-woven substrate by a hot-pressing method at a temperature of about 50-200° C. The pressed non-woven substrate has a thickness of about 25-30 μm.

In another embodiment, the second resin is pressed into the non-woven substrate by a roll-pressing method at a temperature of about 50-200° C. The pressed non-woven substrate has a thickness of about 23-27 μm.

The non-woven substrate is further dried at a temperature of about 70-100° C. after the first or second resin is coated on the non-woven substrate.

In an embodiment, the prepared separator has a pore size ranging from 50 nm to 800 nm and porosity ranging from 40% to 80%.

Another embodiment of the disclosure provides a separator prepared by the disclosed method of fabricating a separator. The separator has a pore size ranging from 50 nm to 800 nm and porosity ranging from 40% to 80%.

Another embodiment of the disclosure provides a separator comprising a porous non-woven substrate and a first resin coated on the non-woven substrate. Specifically, the first resin comprises hydrophilic oxyalkyl compounds, oxyalkyl polymers, oxyalkenyl alkyl polymers or derivatives thereof. The separator has a pore size ranging from 50 nm to 800 nm and porosity ranging from 40% to 80%.

The porous non-woven substrate may comprise polyethylene terephthalate (PET), polyethylene (PE) or polypropylene (PP).

The first resin may be polyoxyethylene alkyl ether, polyoxypropylene alkyl ether, polyoxyethylene alkyl phenyl ether, polyoxyethylene-polyoxypropylene alcohol, polyoxyethylene fatty acid ester, trialkylamine oxide, polyoxyethylene lauric acid ester, polyethylene glycol, polyvinyl alcohol or fatty alcohol polyoxyethylene ether sulfate.

In another embodiment, the separator further comprises a second resin coated on the first resin in addition to a porous non-woven substrate and a first resin. The second resin may comprise hydrophobic poly(vinylidene difluoride) (PVDF), polyacrylonitrile, acrylic, or derivatives thereof or a combination thereof. Additionally, in the second resin, an inorganic material is optionally mixed therein. The inorganic material may comprise aluminum oxide, zirconium oxide, magnesium oxide, titanium oxide, or the like or a combination thereof. The amount of the inorganic material may be 1-5% of the weight of the second resin solution (after the second resin solution is prepared, the inorganic material with an amount of 1-5% of the weight of the second resin solution is added).

The disclosed separator can be directly applied in a variety of currently available thin lithium batteries.

In the disclosure, a porous non-woven fabric (e.g., polyethylene terephthalate (PET), polyethylene (PE) or polypropylene (PP)), having a three-dimensional network structure with softness, thermal stability and more than 80% porosity, is utilized as a separator substrate, combined with the first resin (e.g., hydrophilic resin such as hydrophilic oxyalkyl compounds, oxyalkyl polymers, oxyalkenyl alkyl polymers or derivatives thereof) coated thereon, by using a hot-pressing machine or a roll-pressing machine to press the first resin into the pores of the substrate to fabricate a thin (thickness: less than 30 μm) porous polyolefin separator with more than 50% porosity. The pore size can be further controlled to be less than 1 μm by adjusting resin viscosity (100-20,000 cp), drying temperature and pressing temperature (50-200° C.). Optionally, the non-woven substrate is first pressed to narrow its pore size to about 1 μm before coating the resin thereon. The resin viscosity and pressing temperature are then adjusted to control the pore size of the separator to be less than 1 μm.

### Example 1

### Preparation of the Separator (1)

First, a porous polypropylene (PP) non-woven substrate with a basis weight of 15g/m², a thickness of 70 μm and an air permeability of 2.29 ft³/min/ft² was provided. Next, the polypropylene (PP) non-woven substrate was pressed by a hot-pressing method at a temperature of 70° C. for 4 hours. A hydrophilic fatty alcohol polyoxyethylene ether sulfate solution (the weight ratio of the hydrophilic fatty alcohol polyoxyethylene ether sulfate and water was 1:2) was then coated on the polypropylene (PP) non-woven substrate at a speed of 34 rpm and dried at a temperature of 70. Next, the hydrophilic fatty alcohol polyoxyethylene ether sulfate was pressed into the pores of the polypropylene (PP) non-woven substrate by a hot-pressing method at a temperature of 100° C. to form a porous polypropylene (PP) separator with a thickness of 25-30 μm. The related physical properties of the separator are shown in Table 1.

### Example 2

### Preparation of the Separator (2)

First, a porous polypropylene (PP) non-woven substrate with a basis weight of 15g/m², a thickness of 70 μm and an air permeability of 2.29 ft³/min/ft² was provided. Next, the polypropylene (PP) non-woven substrate was pressed by a hot-pressing method at a temperature of 100° C. for 3 hours. A hydrophilic fatty alcohol polyoxyethylene ether sulfate solution (the weight ratio of the hydrophilic fatty alcohol polyoxyethylene ether sulfate and water was 1:2) was then coated on the polypropylene (PP) non-woven substrate at a speed of 34 rpm and dried at a temperature of 70° C. Next, the hydrophilic fatty alcohol polyoxyethylene ether sulfate was pressed into the pores of the polypropylene (PP) non-woven substrate by a hot-pressing method at a temperature of 100° C. to form a porous polypropylene (PP) separator with a thickness of 25-30 μm. The related physical properties of the separator are shown in Table 1.

### Example 3

### Preparation of the Separator (3)

First, a porous polypropylene (PP) non-woven substrate with a basis weight of 15g/m², a thickness of 70 μm and an air permeability of 2.29 ft³/min/ft² was provided. Next, the polypropylene (PP) non-woven substrate was pressed by a roll-pressing method at a temperature of 60° C. A hydrophilic fatty alcohol polyoxyethylene ether sulfate solution (the weight ratio of the hydrophilic fatty alcohol polyoxyethylene ether sulfate and water was 1:2) was then coated on the polypropylene (PP) non-woven substrate at a speed of 34 rpm and dried at a temperature of 70° C. Next, the hydrophilic fatty alcohol polyoxyethylene ether sulfate was pressed into the pores of the polypropylene (PP) non-woven substrate by a roll-pressing method at a temperature of 60° C. to form a porous polypropylene (PP) separator with a thickness of 25-30 μm. The related physical properties of the separator are shown in Table 1.

### Example 4

### Preparation of the Separator (4)

First, a porous polypropylene (PP) non-woven substrate with a basis weight of 15g/m², a thickness of 70 μm and an air permeability of 2.29 ft³/min/ft² was provided. Next, the polypropylene (PP) non-woven substrate was pressed by a roll-pressing method at a temperature of 100° C. A hydrophilic fatty alcohol polyoxyethylene ether sulfate solution (the weight ratio of the hydrophilic fatty alcohol polyoxyethylene ether sulfate and water was 1:2) was then coated on the polypropylene (PP) non-woven substrate at a speed of 34 rpm and dried at a temperature of 70° C. Next, the hydrophilic fatty alcohol polyoxyethylene ether sulfate was pressed into the pores of the polypropylene (PP) non-woven substrate by a roll-pressing method at a temperature of 100° C. to form a porous polypropylene (PP) separator with a thickness of 25-30 μm. The related physical properties of the separator are shown in Table 1.

### Example 5

### Preparation of the Separator (5)

First, a porous polypropylene (PP) non-woven substrate with a basis weight of 15g/m², a thickness of 70 μm and an air permeability of 2.29 ft³/min/ft² was provided. Next, the polypropylene (PP) non-woven substrate was pressed by a roll-pressing method at a temperature of 60° C. A hydrophilic fatty alcohol polyoxyethylene ether sulfate solution (the weight ratio of the hydrophilic fatty alcohol polyoxyethylene ether sulfate and water was 1:2) was then coated on the polypropylene (PP) non-woven substrate at a speed of 34 rpm and dried at a temperature of 70° C. Next, the hydrophilic fatty alcohol polyoxyethylene ether sulfate was pressed into the pores of the polypropylene (PP) non-woven substrate by a roll-pressing method at a temperature of 100° C. A poly(vinylidene difluoride) (PVDF) (Mw: 50, viscosity: 1,500 cp) solution (the weight ratio of the poly(vinylidene difluoride) (PVDF) and solvent of N-methyl-2-pyrrolidone was 15:85) was then coated on the polypropylene (PP) non-woven substrate at a speed of 34 rpm and placed in a water bath to fix the pore size of the polypropylene (PP) non-woven substrate. After drying at a temperature of 70° C., the poly(vinylidene difluoride) (PVDF) was pressed into the pores of the polypropylene (PP) non-woven substrate by a roll-pressing method at a temperature of 40° C. to form a porous polypropylene (PP) separator with a thickness of 30-35 μm. The related physical properties of the separator are shown in Table 1.

### Example 6

### Preparation of the Separator (6)

First, a porous polypropylene (PP) non-woven substrate with a basis weight of 15g/m², a thickness of 70 μm and an air permeability of 2.29 ft³/min/ft² was provided. Next, the polypropylene (PP) non-woven substrate was pressed by a roll-pressing method at a temperature of 60° C. A hydrophilic fatty alcohol polyoxyethylene ether sulfate solution (the weight ratio of the hydrophilic fatty alcohol polyoxyethylene ether sulfate and water was 1:2) was then coated on the polypropylene (PP) non-woven substrate at a speed of 34 rpm and dried at a temperature of 70° C. Next, the hydrophilic fatty alcohol polyoxyethylene ether sulfate was pressed into the pores of the polypropylene (PP) non-woven substrate by a roll-pressing method at a temperature of 100° C. A poly(vinylidene difluoride) (PVDF) (Mw: 50, viscosity: 1,500 cp) solution (the weight ratio of the poly(vinylidene difluoride) (PVDF) and solvent of N-methyl-2-pyrrolidone was 15:85) mixed with 2% of aluminum oxide (particle size: 13 nm) (after the second resin solution is prepared, the aluminum oxide with an amount of 2% of the weight of the second resin solution was added) was then coated on the polypropylene (PP) non-woven substrate at a speed of 34 rpm and placed in a water bath to fix the pore size of the polypropylene (PP) non-woven substrate. After drying at a temperature of 70° C., the poly(vinylidene difluoride) (PVDF) and aluminum oxide were pressed into the pores of the polypropylene (PP) non-woven substrate by a roll-pressing method at a temperature of 40° C. to form a porous polypropylene (PP) separator with a thickness of 30-35 μm. The related physical properties of the separator are shown in Table 1.

TABLE 1

| | Thick- | Pore | | Dimensional | Po- | |
|---|---|---|---|---|---|---|
| | ness | size | McMullin | stability | rosity | Intensity |
| | (μm) | (μm) | number | (temp.) | (%) | (Nt/5 cm) |
| Example 1 | 25-30 | <1 | <30 | 160° C. | >60 | 14 |
| Example 2 | 25-30 | <1 | <30 | 160° C. | >55 | 12 |
| Example 3 | 25-30 | <1 | <30 | 160° C. | >60 | 17 |
| Example 4 | 25-30 | <1 | <30 | 160° C. | >60 | 15 |
| Example 5 | 30-35 | <0.3 | <25 | 160° C. | >50 | 15 |
| Example 6 | 30-35 | <0.3 | <25 | 160° C. | >55 | 12 |

### Comparative Example 1

### Charge/Discharge of Lithium Battery with a Celgard-2320 Separator

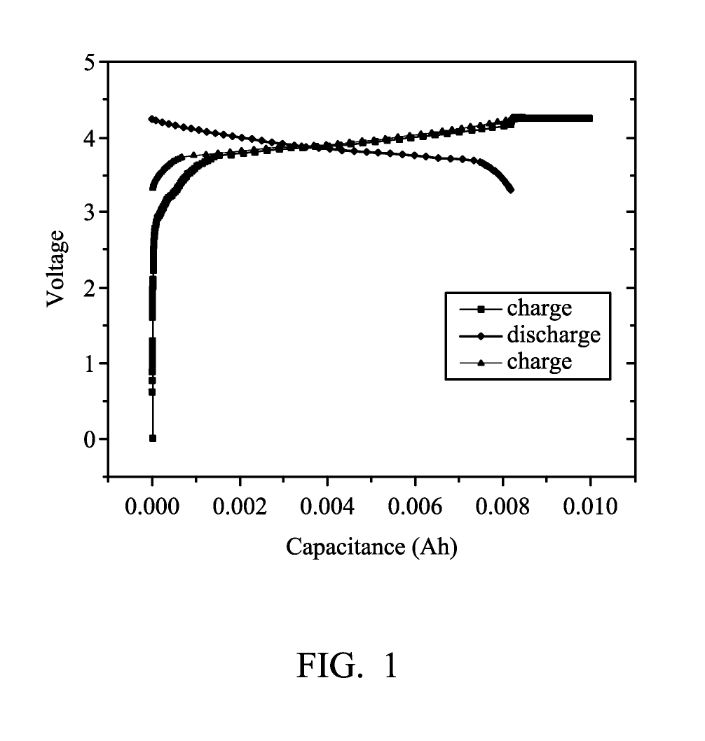

A Celgard-2320 separator (PE/PP/PE three-layered composite film) was cut into a size with a diameter of 2 cm. The cut separator was then combined with an anode (lithium iron phosphate) and a cathode (MCMB) (purchased from SYNergy ScienTech Corp.) and sealed in a battery. The battery was tested with a voltage of 3.65V. The charge/discharge results of the battery are shown in FIG. 1.

### Example 7

### Charge/Discharge of Lithium Battery with the Separator

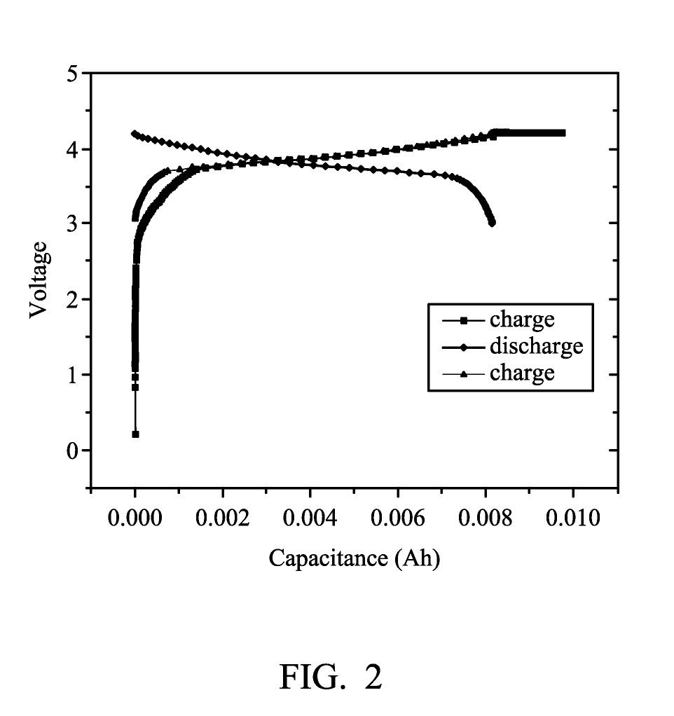

The separators of Examples 4-6 were cut into a size with a diameter of 2 cm, respectively. The cut separator was then combined with an anode (lithium iron phosphate) and a cathode (MCMB) (purchased from SYNergy ScienTech Corp.) and sealed in a battery. The battery was tested with a voltage of 3.65V. The charge/discharge results of the battery are shown in FIG. 2. In accordance with FIG. 2, the charge/discharge efficiency of the lithium battery was very stable.

### Example 8

### Capacitance of the Separator

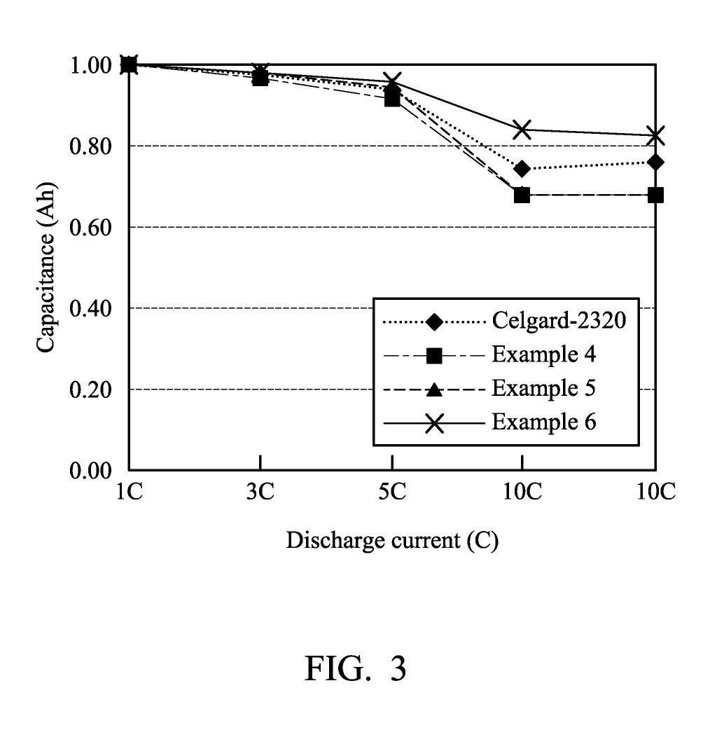

The separators of Examples 4-6 and the Celgard-2320 separator were cut into a size of 11*6 cm², respectively. The cut separator was then combined with an anode (lithium iron phosphate) and a cathode (MCMB) (purchased from SYNergy ScienTech Corp.) and sealed in a battery. The battery was charged by applying current 1C (1C=5 mAh) and discharged by applying current 1C, 3C, 5C, 10C and 10C, respectively. The charge/discharge results of the battery are shown in FIG. 3. In accordance with FIG. 3, the separator (Example 6) had higher capacitance than that of the Celgard-2320 separator under large current (10C).

While the disclosure has been described by way of example and in terms of preferred embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method of fabricating a separator, comprising the following steps:
providing a porous non-woven substrate; and
coating a first resin on the non-woven substrate, wherein the first resin comprises hydrophilic oxyalkyl compounds, oxyalkyl polymers, oxyalkenyl alkyl polymers or derivatives thereof.

2. The method of fabricating a separator as claimed in claim 1, wherein the non-woven substrate comprises polyethylene terephthalate (PET), polyethylene (PE) or polypropylene (PP).

3. The method of fabricating a separator as claimed in claim 1, further comprising pressing the first resin into the pores of the non-woven substrate after coating the first resin on the non-woven substrate.

4. The method of fabricating a separator as claimed in claim 3, wherein the first resin is pressed into the non-woven substrate by a hot-pressing method.

5. The method of fabricating a separator as claimed in claim 4, wherein the first resin is pressed into the non-woven substrate at a temperature of about 50-200° C.

6. The method of fabricating a separator as claimed in claim 3, wherein the first resin is pressed into the non-woven substrate by a roll-pressing method.

7. The method of fabricating a separator as claimed in claim 6, wherein the first resin is pressed into the non-woven substrate at a temperature of about 50-200° C.

8. The method of fabricating a separator as claimed in claim 3, further comprising coating a second resin on the non-woven substrate after pressing the first resin into the non-woven substrate, wherein the second resin comprises hydrophobic poly(vinylidene difluoride) (PVDF), polyacrylonitrile, acrylic, or derivatives thereof or a combination thereof.

9. The method of fabricating a separator as claimed in claim 8, further comprising mixing an inorganic material in the second resin.

10. The method of fabricating a separator as claimed in claim 9, wherein the inorganic material comprises aluminum oxide, zirconium oxide, magnesium oxide, titanium oxide, or a combination thereof.

11. A separator, prepared by the method of fabricating a separator as claimed in claim 1, wherein the separator has a pore size ranging from 50 nm to 800 nm and porosity ranging from 40% to 80%.

12. A separator, comprising:
a porous non-woven substrate; and
a first resin coated on the non-woven substrate, wherein the first resin comprises hydrophilic oxyalkyl compounds, oxyalkyl polymers, oxyalkenyl alkyl polymers or derivatives thereof, and the separator has a pore size ranging from 50 nm to 800 nm and porosity ranging from 40% to 80%.

13. The separator as claimed in claim 12, wherein the non-woven substrate comprises polyethylene terephthalate (PET), polyethylene (PE) or polypropylene (PP).

14. The separator as claimed in claim 12, further comprising a second resin, wherein the second resin is coated on the first resin, wherein the second resin comprises hydrophobic poly(vinylidene difluoride) (PVDF), polyacrylonitrile, acrylic, or derivatives thereof or a combination thereof.

15. The separator as claimed in claim 14, further comprising an inorganic material mixed in the second resin.

16. The separator as claimed in claim 15, wherein the inorganic material comprises aluminum oxide, zirconium oxide, magnesium oxide, titanium oxide, or the like or a combination thereof.
